(19) United States
(12) Patent Application Publication
(10) Pub. No.: US 2011/0063659 A1
(43) Pub. Date: Mar. 17, 2011

(54) CONTROL METHOD, INFORMATION PROCESSING APPARATUS, AND COMPUTER-READABLE MEDIUM

(75) Inventor: Masayuki Sakura, Kawasaki-shi (JP)

(73) Assignee: CANON KABUSHIKI KAISHA, Tokyo (JP)

(21) Appl. No.: 12/852,608

(22) Filed: Aug. 9, 2010

(30) Foreign Application Priority Data
Sep. 11, 2009 (JP) 2009-211026

(51) Int. Cl. G06F 15/00

(52) U.S. Cl. 358/1.15

(57) ABSTRACT

A control method comprises an item determination step of determining, upon switching of output target printing apparatuses between a plurality of printing apparatuses corresponding to the plurality of printer drivers, whether or not setting items in setting information before switching and setting items according to a printing apparatus after switching include common setting items; a set value determination step of determining whether or not set values in the setting information before switching and default set values of the printing apparatus after switching are different in the common setting items determined in the item determination step; and an output step of outputting, when it is determined in the set value determination step that the set values are different, a message indicating that set values different from the default set values of the printing apparatus after switching are set upon switching of the printing apparatuses.

### BACKGROUND OF THE INVENTION

1. Field of the Invention

The present invention relates to a notification technique of set values of printer drivers.

2. Description of the Related Art

Conventionally, methods have been proposed in association with handling of print set values when a user switches printer drivers in an environment in which a plurality of printer drivers are installed in an information processing apparatus. When the user switches printer drivers on the information processing apparatus in which the plurality of printer drivers are installed, operations associated with print set values are different depending on the operating systems (OSs) of the apparatuses. That is, for those operations multiple methods exist.

On certain OSs, printer drivers operate independently. In this case, when the user switches a printer (printer driver) to be used as an output target, print values of a printer driver set before switching are independent of those after switching. For this reason, even when the user changes the print set values of the printer driver before switching, the altered print settings are not reflected after the printer driver is switched. Japanese Patent Laid-Open No. 2003-131832 has proposed a method of handing over print set values upon switching printer drivers premised on the OS which performs such operation. In this invention, upon switching printer drivers, it is determined if the printer drivers before and after switching are of an identical type. If it is determined that these printer drivers are of an identical type, setting information set for the printer driver before switching is handed over intact to those after switching.

On another OS different from the aforementioned OS, once a printer driver is selected, the OS itself holds crossover print settings for a plurality of switchable printer drivers until a print job is complete or canceled later. When the user switches printer drivers, the OS intervenes to hand over the print settings of the printer drivers before and after change, thus sharing the same settings.

A problem to be solved by the present invention is premised on a print system in which an OS holds crossover print set values for printer drivers, as described in the related arts. Hereinafter, the OS that has such the feature is called a specific OS.

A user merit of this specific OS appears in a case in which after the user makes print settings for a certain printer driver, an output target printer is not a desired one of the user, and he or she switches the printer drivers. When set values are not handed over between the printer drivers, the user has to re-set desired print settings for the printer driver after switching in the above situation. By contrast, when the specific OS holds the crossover print set values between the printer drivers, settings made for a certain printer driver are passed to another printer driver after switching, and the user need not make print settings again, thus providing a merit.

On the other hand, a printer driver itself often defines, as default values, print set values suited to a corresponding printer, and associates these default values with the printer. Of course, when the user wants to perform a print operation that fully uses the performance of a printer, it is desirable to use these default values unless otherwise designated by the user, when a certain printer is determined as an output target.

However, such an OS poses a problem when, for example, printer drivers before and after switching have different default set values for identical setting items. More specifically, a case will be examined below wherein in association with two printer drivers which allow both monochrome and color settings, a default value of printer driver A is “monochrome”, and that of printer driver B is “color”. At this time, when the user switches from printer driver A to printer driver B, since the default value of printer driver B is “color”, it is expected that the monochrome/color setting is also switched to “color”. However, since the specific OS controls handover of print set values, the monochrome/color setting of printer driver A is handed over to that of printer driver B, and the monochrome/color setting of printer driver B is still “monochrome”.

The user can name and save a combination of some setting items and their values in advance in association with print settings, and such combinations are called presets. When a preset is set, a user can easily perform an output operation using print settings which are defined in advance. However, when the user switches printer drivers after he or she sets the preset, settings of the preset are invalidated in some cases.

For example, assume that a color/monochrome setting in a given preset is “color”. A case will be examined below wherein printer driver A corresponds to a color-dedicated printer, and printer driver B corresponds to a monochrome-dedicated printer. At this time, when the user sets that preset in printer driver A, a setting desired by the user for the color/monochrome setting is “color”. A case will be examined below wherein the user changes the printer driver to printer driver B by, for example, re-selecting a printer, and then returns the printer driver to printer driver A again. When printer driver B is selected, since it corresponds to the monochrome printer, the color/monochrome setting is inevitably set to be “monochrome”. After that, in an environment using the aforementioned specific OS, when the user returns the printer driver to printer driver A, the monochrome set value of the color/monochrome setting is handed over against the intention of the user who selected the preset. In this case, since the user selects the preset including the set value “color”, a color print operation is to be made without any setting operations, but a monochrome print operation is undesirably made unless the user changes the setting.

### SUMMARY OF THE INVENTION

The present invention provides a method which can solve the aforementioned problems, that is, a method which flexibly detects print set values which are not to be handed over, and preset settings which are to be validated, and notifies the user of them in an environment using above-mentioned specific OS. Also, the present invention calls the issue to the user's attention by notifying the user of occurrences of setting changes and their contents.

According to one aspect of the present invention, there is provided a control method of an information processing apparatus in which a plurality of printer drivers for setting set values in setting items of print data to be output by a printing apparatus are installed, the method comprising: under the control of an operating system having a function of controlling the plurality of printer drivers to share set values set using the plurality of printer drivers, an item determination step of determining, upon switching of output target printing apparatuses between a plurality of printing apparatuses corresponding to the plurality of printer drivers, whether or not setting items in setting information before switching and setting items according to a printing apparatus after switching include common setting items; a set value determination step of determining whether or not set values in the setting information before switching and default set values of the printing apparatus after switching are different in the common setting items determined in the item determination step; and an output step of outputting, when it is determined in the set value determination step that the set values are different, a message indicating that set values different from the default set values of the printing apparatus after switching are set upon switching of the printing apparatuses.

According to another aspect of the present invention, there is provided a control method of an information processing apparatus in which a plurality of printer drivers for setting set values in setting items of print data to be output by a printing apparatus are installed, the method comprising: under the control of an operating system having a function of controlling the plurality of printer drivers to share set values set using the plurality of printer drivers, a storage step of storing a preset which defines, in advance, print setting items and set values to be set in the print data; a preset item determination step of determining, upon switching of output target printing apparatuses between a plurality of printing apparatuses corresponding to the plurality of printer drivers, whether or not setting items of the preset and the setting items according to the printing apparatus after switching include common setting items; a preset set value determination step of determining whether or not the set values of the preset and the set values set in the common setting items upon switching of the printing apparatuses are different in the common setting items determined in the preset item determination step; and an output step of outputting, when it is determined in the preset set value determination step that the set values are different, a message indicating set values different from the set values of the preset are set upon switching of the printing apparatus.

According to another aspect of the present invention, there is provided an information processing apparatus in which a plurality of printer drivers for setting set values in setting items of print data to be output by a printing apparatus are installed, the apparatus comprising: under the control of an operating system having a function of controlling the plurality of printer drivers to share set values set using the plurality of printer drivers, an item determination unit which determines, upon switching of output target printing apparatuses between a plurality of printing apparatuses corresponding to the plurality of printer drivers, whether or not setting items in setting information before switching and setting items according to a printing apparatus after switching include common setting items; a set value determination unit which determines whether or not set values in the setting information before switching and default set values of the printing apparatus after switching are different in the common setting items determined by the item determination unit; and an output unit which outputs, when the set value determination unit determines that the set values are different, a message indicating that set values different from the default set values of the printing apparatus after switching are set upon switching of the printing apparatuses.

According to another aspect of the present invention, there is provided an information processing apparatus in which a plurality of printer drivers for setting set values in setting items of print data to be output by a printing apparatus are installed, the apparatus comprising: under the control of an operating system having a function of controlling the plurality of printer drivers to share set values set using the plurality of printer drivers, a storage unit which stores a preset which defines, in advance, print setting items and set values to be set in the print data; a preset item determination unit which determines, upon switching of output target printing apparatuses between a plurality of printing apparatuses corresponding to the plurality of printer drivers, whether or not setting items of the preset and the setting items according to the printing apparatus after switching include common setting items; a preset set value determination unit which determines whether or not the set values of the preset and the set values set in the common setting items upon switching of the printing apparatuses are different in the common setting items determined by the preset item determination unit; and an output unit which outputs, when the preset set value determination unit determines that the set values are different, a message indicating that set values different from the set values of the preset are set upon switching of the printing apparatus.

The present invention can provide a method which flexibly detects print set values which are not to be handed over, and preset settings which are to be validated, and notifies the user of them in an environment using above-mentioned specific OS.

Further features of the present invention will become apparent from the following description of exemplary embodiments (with reference to the attached drawings).

### BRIEF DESCRIPTION OF THE DRAWINGS

FIG. 1 is a view showing an example of the arrangement of a print system according to an embodiment of the present invention;

FIG. 2 is a block diagram of a client computer according to the embodiment;

FIG. 3 is a diagram showing the module configuration of a printer driver according to the embodiment;

FIG. 4 is a flowchart of a printer driver installation method according to the embodiment;

FIG. 5 is a flowchart of a print queue registration method according to the embodiment;

FIGS. 6A and 6B are views showing an example of a print queue registration UI according to the embodiment;

FIG. 7 is a block diagram showing the configuration of a printer driver system according to the embodiment;

FIG. 8 is a view showing examples of definition files according to the embodiment;

FIG. 9 is a view showing an example of registered printer specification description files according to the embodiment;

FIG. 10 is a view showing an example of a print setting dialog according to the embodiment;

FIG. 11 is a view showing examples of definition files according to the embodiment;

FIG. 12 is a flowchart showing a user's print operation according to the embodiment;

FIG. 13 is a view showing examples of definition files according to the embodiment;

FIGS. 14A and 14B are flowcharts showing the operation of the printer driver according to the embodiment;

FIGS. 15A and 15B are tables showing examples of set values of respective setting items according to the embodiment; and

FIGS. 16A to 16D are views showing examples of message display dialogs according to the embodiment.

### DESCRIPTION OF THE EMBODIMENTS

### First Embodiment

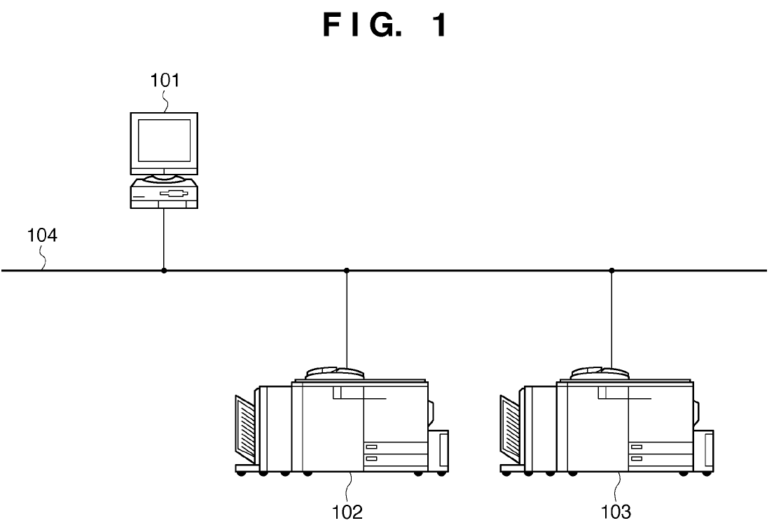

FIGS. 1 to 13 depict the first embodiment of the present invention.

[System Arrangement]

FIG. 1 depicts an example of a print system required to implement a control method according to the present invention. To a computer network 104, a client computer 101 as an information processing apparatus, and network printers 102 and 103 are connected. In the client computer 101, an operating system (to be abbreviated as an OS hereinafter), applications, and a plurality of printer drivers are installed. With this print system, the user can transmit user data from the client computer 101 to the network printer 102 or 103, and can print it out. Hereinafter, term “OS” means “specific OS” described in description of the related art.

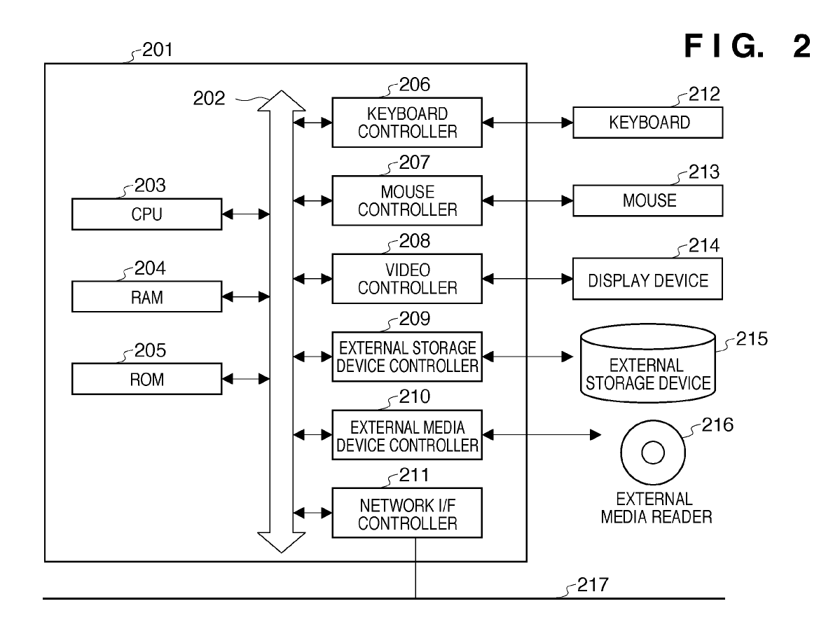

FIG. 2 is an internal block diagram of the client computer 101. A client computer 201 shown in FIG. 2 is the same as the client computer 101. The client computer includes a central processing unit (CPU) 203, a RAM 204 as a volatile memory, a ROM 205 as a nonvolatile memory, a keyboard controller 206, a mouse controller 207, a video controller 208, an external storage device controller 209, an external media device controller 210, and a network I/F controller 211. A keyboard 212 and mouse 213 used by the user to operate the client computer 201 are respectively connected to the keyboard controller 206 and mouse controller 207 of the client computer 201. A display device 214 is connected to the video controller 208 of the client computer 201. A nonvolatile external storage device 215 used to save large-capacity data is connected to the external storage device controller 209, and undergoes read/write accesses of applications and data. When an application, driver software, and the like are provided using external media (CD-ROM, DVD-ROM, etc.), the user sets an external medium on an external media reader 216, and the external media device controller 210 can load a program from the external medium. Note that the computer network 104 described in FIG. 1 is connected to the network I/F controller 211 to communicate with other devices.

Normally, an initial program required to activate the client computer 201, and a basic program required to control respective modules of the client computer 201 are saved in the ROM 205. Also, the OS, applications, and printer drivers are saved in the external storage device 215. When the power switch of the client computer 201 is turned on, a program (boot loader) is executed which is saved in the ROM 205 and is required to activate the computer. That program loads the OS saved in the external storage device 215 into the RAM 204, and then passes control directly to the OS. The OS further loads required modules and drivers from the external storage device 215 into the RAM 204. Also, the OS loads required applications from the external storage device 215 into the RAM 204 in response to user instructions, and executes loaded programs.

Printer drivers and their installers to be described in this embodiment are provided using external media such as a CD-ROM, each of which is set in the external media reader 216. Then, the CPU 203 loads printer drivers or installers into the RAM 204 or saves them in the external storage device 215 as required. The OS used in the present invention includes, for example, “Mac OS X” (trademark) available from Apple.

[Printer Driver Installation and Print Queue Registration]

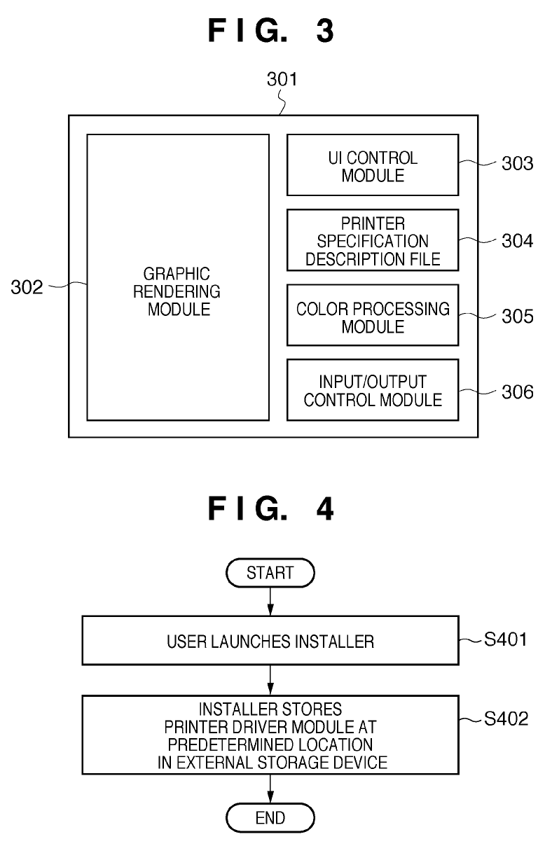

A printer driver will be described below with reference to FIG. 3. The printer driver prepared at the time of installation includes modules, as shown in FIG. 3. A printer driver 301 includes a graphic rendering module 302, UI control module 303, printer specification description file 304, color processing module 305, and input/output control module 306. Note that the present invention is not limited to such a specific configuration, and the printer driver may include other modules depending on its function.

The printer driver has some generation methods. For example, in one method, in order to support a plurality of printers using a single printer driver, the graphic rendering module 302 and UI control module 303 are generated to be able to support a plurality of printers. The printer specification description file 304 is supplied with a printer driver in accordance with a printer to be supported. In this method, the UI control module 303 displays or controls a UI in correspondence with the printer specification description file 304. The graphic rendering module 302 is configured to issue a page description language and printer control commands in correspondence with each printer.

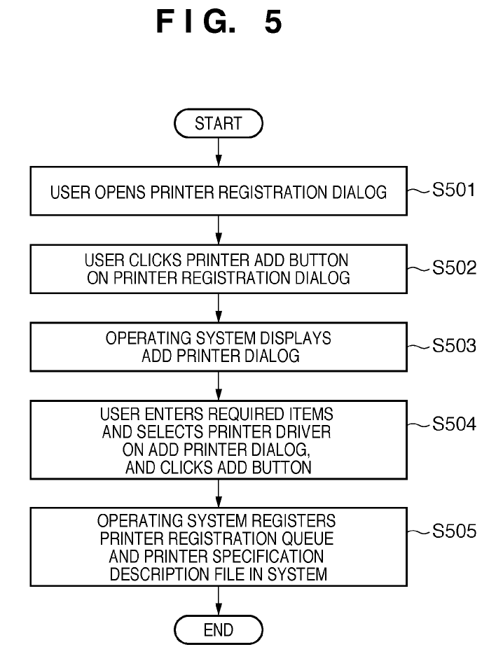

The sequence for installing the printer driver with the above configuration in the client computer 201 will be described below with reference to FIG. 4. Assume that the user possesses a recording medium such as a CD-ROM which stores a printer driver, or acquires a printer driver installer via the network. In step S401, the user launches the acquired printer driver installer. In response to this action, the installer stores printer driver modules at a predetermined location of the external storage device in step S402. Storage locations are different depending on print systems. For example, a CUPS (Common Unix Printing System) is set to store printer driver modules for respective vendors under the following directory:

/Library/Printers/

Furthermore, printer drivers can be stored in correspondence with their types under the directory for each vendor. For example, when different printer drivers PDL1 and PDL2 of vendor “ABC” are available, the following directories are created, and these printer drivers can be stored under these directories.

/Library/Printers/ABC/PDL1/

/Library/Printers/ABC/PDL2/

In step S402, the installer stores printer driver modules under the aforementioned directory in the external storage device 215. The installation of the printer driver is complete. However, in order to output data using a desired printer in practice, the user must register a print queue corresponding to the desired printer according to a sequence defined by, for example, the OS.

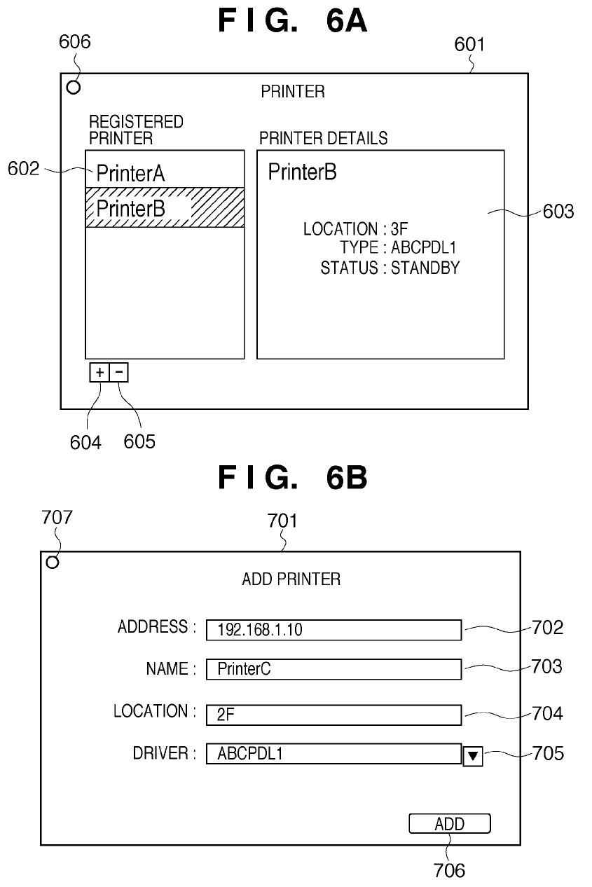

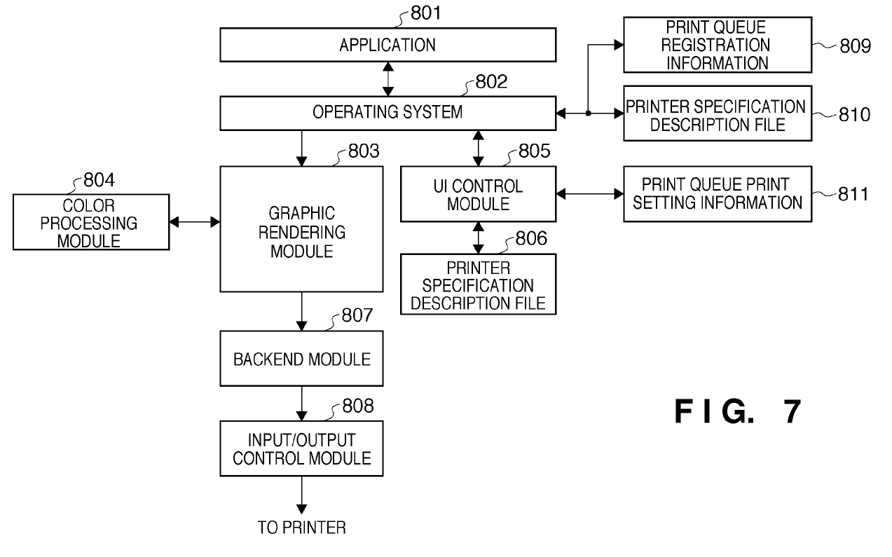

FIG. 5 shows the sequence for registering a print queue. The sequence of processing will be described along this sequence using the drawings. In step S501, the user opens a printer registration dialog 601 required to register a print queue. In this step, the OS reads out a program code for printer registration from the external storage device 215 into the RAM 204, and executes the read out program. FIG. 6A shows an example of a user interface (to be abbreviated as a UI hereinafter) of the printer registration dialog displayed by the OS. This dialog includes a registered print list 602 used to display a list of printers, print queues of which are currently registered, and a printer detail display area 603 used to display detailed information of a printer selected on the registered print list 602. Also, the dialog includes a print queue add button 604 used to register a print queue, a button 605 used to delete a printer currently selected on the registered print list 602, and a button 606 used to close this dialog.

In step S502, the user clicks the print queue add button 604 on the printer registration dialog 601. In response to this user operation, the OS displays an add printer dialog 701 in step S503. The user enters required information in the displayed add printer dialog 701 in step S504 to add a printer. FIG. 6B shows an add printer dialog displayed by the OS. The add printer dialog 701 includes a setting field 702 used to designate a network address (an IP address in this example) of a connected printer, a setting field 703 used to input a name required to identify a print queue, and a setting field 704 used to input an installation location of the printer. The printer name 703 and location 704 on this dialog include character strings used when they are displayed on the registered print list 602 and printer detail display area 603 of the printer registration dialog. The add printer dialog 701 also includes a setting field 705 used to designate a printer driver used upon registration of a print queue. Note that the configuration of the add printer dialog 701 shown in FIG. 6B is an example, and additional information (e.g., information regarding a license key) may be input as needed. The registered print queue is displayed in the registered print list shown in FIG. 6A. In the setting field 705, the OS lists up printer drivers stored under the printer driver storage directory (/Library/Printers/) of the OS described above.

The example of FIG. 6B shows a state in which the user inputs an address “192.168.1.10”, a print queue name “PrinterC”, and a location “2F”, and selects a printer driver “ABC PDL1”. When the user clicks the add button 706 in this state, the OS adds a print queue. As a result, a printer that can be used by the user is additionally registered. When the user wants to close this dialog without adding any printer, he or she clicks a button 707.

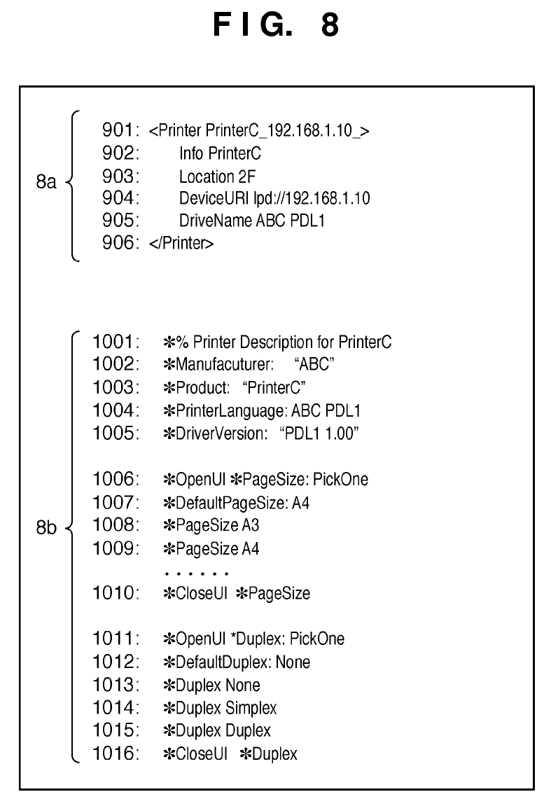

In step S505, the OS registers the print queue designated by the user in the system. This step will be described in detail below using FIGS. 7 to 9.

FIG. 7 is a system block diagram showing a state in which the printer driver has already been installed, and the print queue has already been registered. Referring to FIG. 7, a graphic rendering module 803 corresponds to the graphic rendering module 302 of the printer driver, which is installed under the predetermined directory (/Library/Printers/) of the OS in the aforementioned sequence. Likewise, a UI control module 805 corresponds to the UI control module 303 of the installed printer driver. A color processing module 804 corresponds to the color processing module 305 of the installed printer driver. An input/output control module 808 corresponds to the input/output control module 306 of the installed printer driver. A printer specification description file 806 corresponds to the printer specification description file 304 of the installed printer driver. Note that a backend module 807 is provided by the OS, and is used to pass over print data generated by the graphic rendering module 803 to the input/output control module 808 used to transmit the print data to the printer. Also, print queue registration information 809, a printer specification description file 810, and a printer setting file 811 are generated by the OS during the printer registration process in FIG. 5, and will be described in detail below.

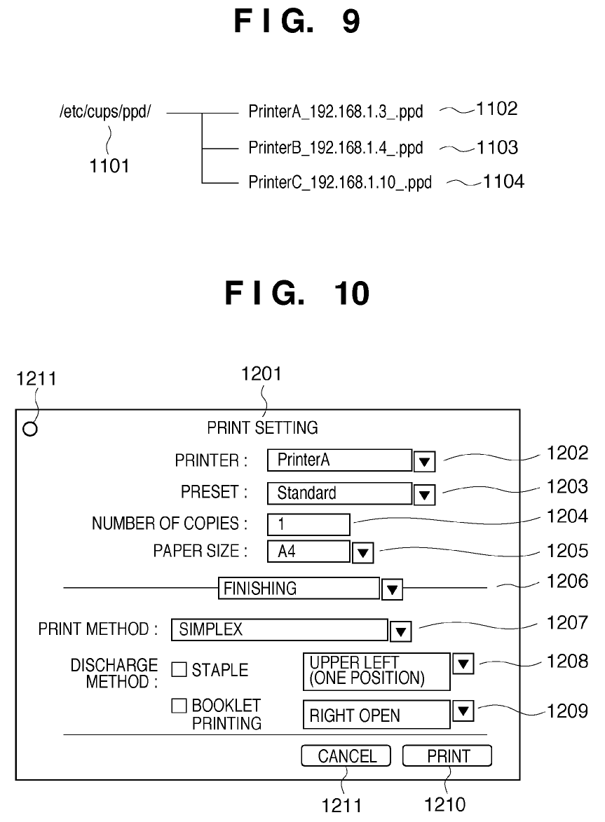

In step S505, an OS 802 acquires information input to the add printer dialog, and executes printer registration processing. This registration is executed as follows. Description 8a in FIG. 8 shows a file which describes information of a print queue to be registered, and is described in a markup language. A line 901 indicates an identifier of the print queue, which is described by tying a printer name and printer address by an underscore. Also, lines 902 and 903 respectively describe a printer name and location. Furthermore, a line 904 includes a description of an address of the print queue, and indicates to transmit data to an address “192.168.1.10” by the lpd protocol in this example. A line 905 describes a printer driver name (ABC PDL1 in this case) used by this printer. A line 906 corresponds to the line 901, and indicates the end of the description. The OS creates this description file in step S505, and additionally records this printer registration information in a predetermined file in the external storage device 215. As this predetermined file, for example, the OS records information in a printers.conf file stored under a /etc/cups/ directory in the CUPS (Common Unix Printing System). This is the print queue registration information 809. When a plurality of print queues are registered, the printers.conf file repetitively includes description 8a in FIG. 8 corresponding to respective printers for respective print queues.

In step S505, the OS then registers the printer specification description file in the system. In FIG. 7, the OS 802 acquires the printer specification description file 806 of the printer to be registered from the UI control module of the printer driver, and then registers a generated printer specification description file 810 at a predetermined location of the system.

Prior to the description of the registration method of the printer specification description file, the printer specification description file will be explained. Description 8b in FIG. 8 shows an example of the printer specification description file. This file is described according to a specification description format of the printer. The file will be described below based also on the format.

A line 1001 describes a comment. The comment includes “*%” at the line head. A line 1002 describes a vendor name. A line 1003 describes a printer name supported by this printer specification description file. A line 1004 describes a page description language supported by this printer specification description file. A line 1005 describes a version of the printer driver. A line 1006 and subsequent lines describe function specifications of this printer. In the function specifications, one function is defined in lines 1006 to 1010.

The line 1006 includes a function name with a prefix “*” after “*OpenUI”, and a type of a print set value used upon selecting the function, which is delimited by “:” after the function name. The type of the print set value includes “PickOne” and “Boolean”. “PickOne” expresses a function of selecting one from options. “Boolean” expresses that this function is controlled by On/Off.

The line 1006 expresses that a function “*PageSize” is available, and is to select one from options. A line 1007 describes a default value of the function indicated by the line 1006. The line 1007 starts with “*Default”, and the function name defined in the previous line 1006 is appended after “*Default”. This line indicates that the default value of the function “PageSize” is “A4”. From the line 1007 until “*CloseUI” in a line 1010, each of options of this function is described per line. For example, a line 1008 expresses that “A3” is available as one of options of “PageSize”. Note that these lines describe the function of selecting a page size, and since there are many options of the page size, descriptions of some options are not shown. A last description of this function is the line 1010, which describes the function name described in “*OpenUI” after “*CloseUI”. These lines express one function.

Subsequently, lines 1011 to 1016 include descriptions of another function. A repetitive description will be avoided. This block expresses that a function “Duplex” is available, and is to select one of options (PickOne), which include “None”, “Simplex”, and “Duplex”. In practice, this expresses a duplex print designation function: “None” follows a default setting of the printer without any designation; “Simplex” means simplex printing; and “Duplex” means duplex printing.

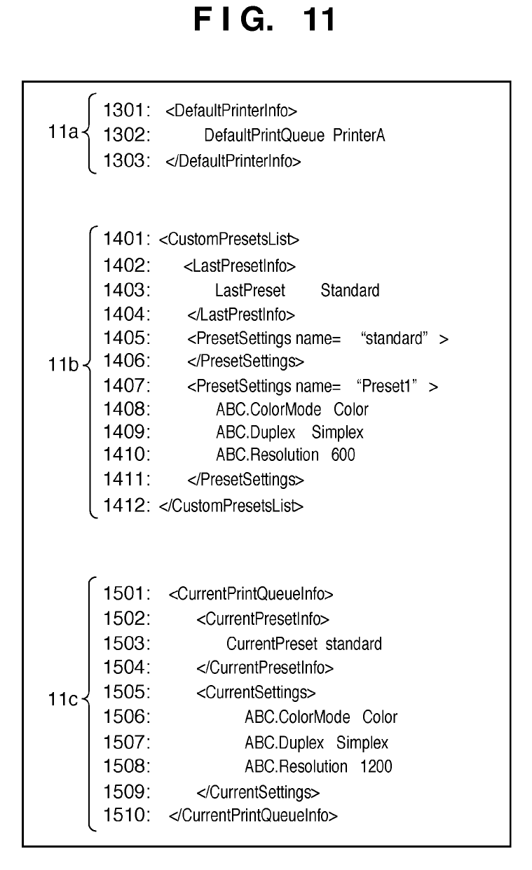

The method of registering this printer specification description file by the OS will be described below. The OS acquires this printer specification description file 806 corresponding to the printer from the UI control module 805, and stores it at a predetermined location of the system. FIG. 9 shows the storage location and that file. The storage location is under a /etc/cups/ppd/ directory in the external storage device 215, and the stored file has a file name obtained by appending the printer name and printer address which are tied by an underscore. For example, a printer specification description file added in this case is “PrinterC_{—}192.168.1.10_.ppd” in a line 1104. FIG. 7 indicates that the OS 802 stores the printer specification description file in the printer specification description file 810. With the aforementioned steps, the registration of the print queue is complete.

[Print Queue and Preset Settings]

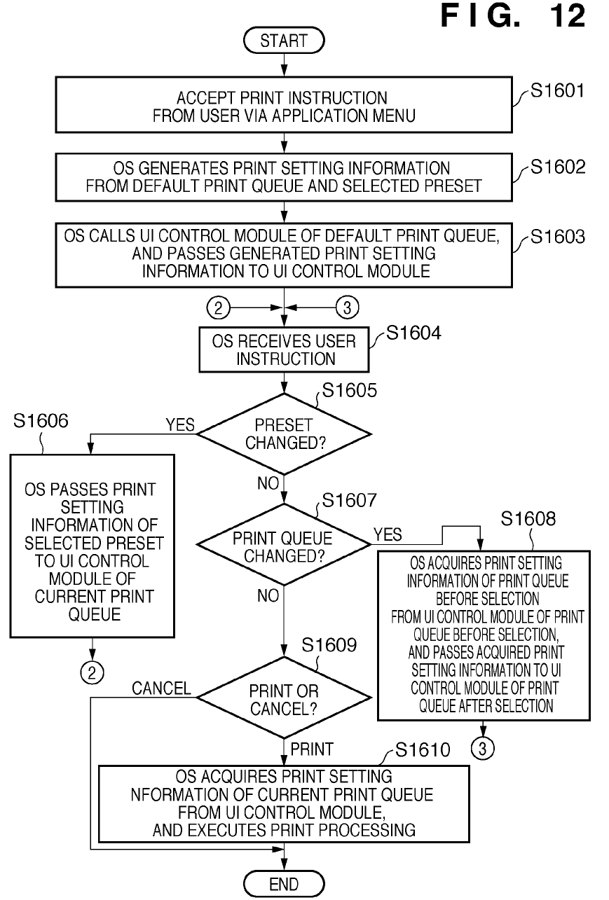

The print queue and preset settings will be described below. FIG. 10 shows a UI that indicates a screen associated with print settings of the registered print queue. This screen is a dialog displayed when the user selects a menu “print” included in, for example, a file menu of an application. Using this dialog, the user makes print settings, and inputs a print request to the printer.

On a print setting dialog 1201, the system commonly provides setting fields 1202 to 1205. This dialog allows the user to select an output target printer (print queue) and a preset (to be described later), to set the number of copies, and to designate a paper size as basic functions. Also, the user can additionally set functions unique to each of various printers. When the printer includes many functions, a method of switching a function group using a setting field 1206 without displaying all the functions at the same time is adopted. This dialog shows a display state of functions related to “finishing”. The finishing related functions include a simplex/duplex designation in a setting field 1207, a staple designation in a setting field 1208, and a booklet print designation in a setting field 1209. Note that the present invention is not limited to the functions listed in this case, but various other functions are available and can be selectively displayed by designating another group using the setting field 1206. Also, the present invention is not limited to the configuration of the dialog shown in FIG. 10, and setting items may be added or deleted as needed.

When the user wants to switch an output destination printer on the print setting dialog 1201, he or she changes a printer using a print selection setting field 1202. On the print setting dialog 1201, a print queue “PrinterA” is currently selected. When the user clicks the setting field 1202 and selects, for example, “PrinterB”, a print queue “PrinterB” is selected on this dialog. Then, when the user clicks a print button 1210 in this state, print data is output to “PrinterB”.

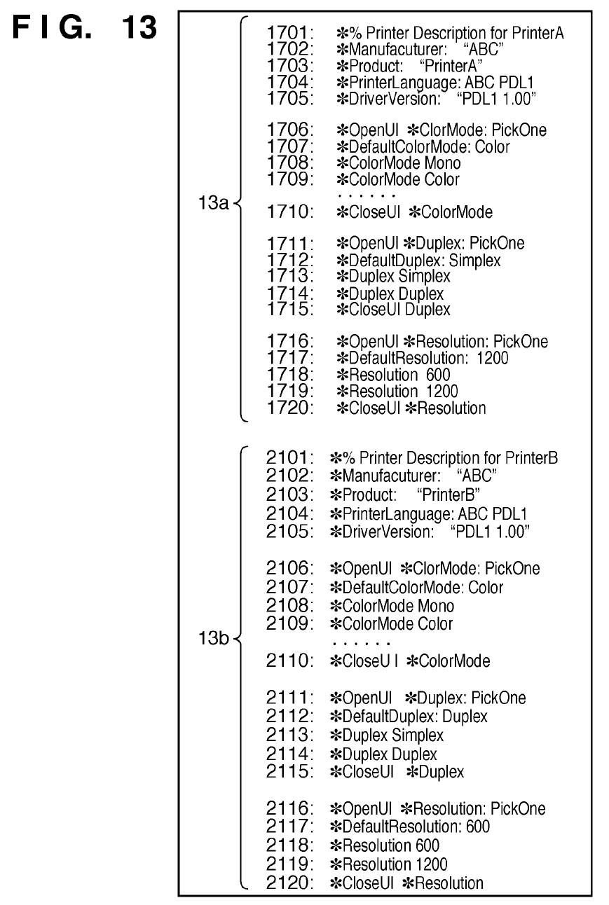

Default settings and a preset saved by the OS will be described below. Description 11a in FIG. 11 shows a file which saves a print queue selected as a default. Lines 1301 and 1303 include descriptions indicating a default print queue. The print queue selected as a default is described within these tags using a key “DefaultPrintQueue”, and a line 1302 indicates that “PrinterA” is selected. Note that this file is saved to have a file name “defaultprinter.plist” under the following directory, since it is saved for each user (in case of a user name “USER_A”).

/usr/USER_A/Library/Preferences/

Description 11b in FIG. 11 shows a file which saves setting contents of a preset. The preset is used to save a combination of print settings frequently used by the user by giving a name in advance. For example, assume that default settings of a certain print queue include “simplex” and “1-up print”. However, when the user frequently uses “duplex” and “2-up print”, he or she sets “duplex” and “2-up” by opening the print setting dialog 1201, and saves these settings as a preset by giving an appropriate name. When the user wants to use these settings, he or she need only select the saved preset in a preset selection setting field 1203, thus reproducing the saved settings. The setting and saving processes of this preset will be described below.

In description 11b in FIG. 11, setting contents of a plurality of presets are described between “CustomPresetList” tags described in correspondence with lines 1401 and 1412. One preset is described within “PresetSettings” tags, as described in lines 1405 and 1406. Note that a preset name is described as a parameter of “PresetSettings”. The lines 1405 and 1406 describe that the preset indicated by these lines has a preset name “Standard” and setting contents of this preset are “NULL”. The preset description file shown in description 11b in FIG. 11 describes another preset, that is, a preset with a name “Preset1” described in lines 1407 to 1411. The setting contents of this preset are described in lines 1408 to 1410. The line 1408 indicates ColorMode=“Color”, the line 1409 indicates Duplex=“Simplex”, and the line 1410 indicates Resolution=“600”. Note that an identifier “ABC.” is appended in front of each item. This identifier is appended to distinguish respective setting items for respective vendors since the presets are managed by the OS and are used common to each vendor. As described above, the types and setting contents of presets are defined by this preset description file.

Description 11c in FIG. 11 shows print setting information to be passed to the UI control module 805, when the user selects “print” from an application menu, and the OS 802 calls the UI control module 805 of the current print queue at that time. The OS 802 generates this information regarding a memory in an application process, and passes it to the UI control module 805. The contents of this information will be described below. The currently selected preset is described in “CurrentPresetInfo” tags in lines 1502 and 1504. The OS 802 acquires this information from the line 1403 in description 11b in FIG. 11, and describes the acquired information in these tags. These tags indicate that a preset “Standard” is currently selected. Then, print setting contents are described between lines 1505 and 1509. The print settings are described between “CurrentSettings” tags in the lines 1505 and 1509. Since the contents of these settings are the same as those in description 11b in FIG. 11, a description thereof will not be repeated.

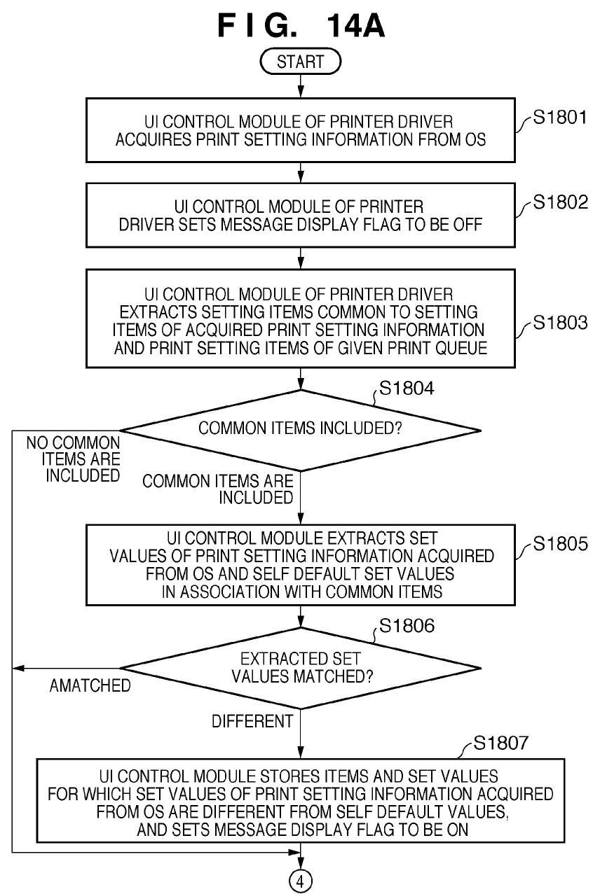

Events generated from when the user inputs a print instruction until a print operation is executed, and operations to be executed in response to these events will be described below with reference to FIG. 12.

In step S1601, a “print” selection instruction from an application menu is accepted as a user instruction. In response to this operation, the OS generates print setting information from a default print queue and a preset which is selected in advance, in step S1602. More specifically, the OS generates the following information.

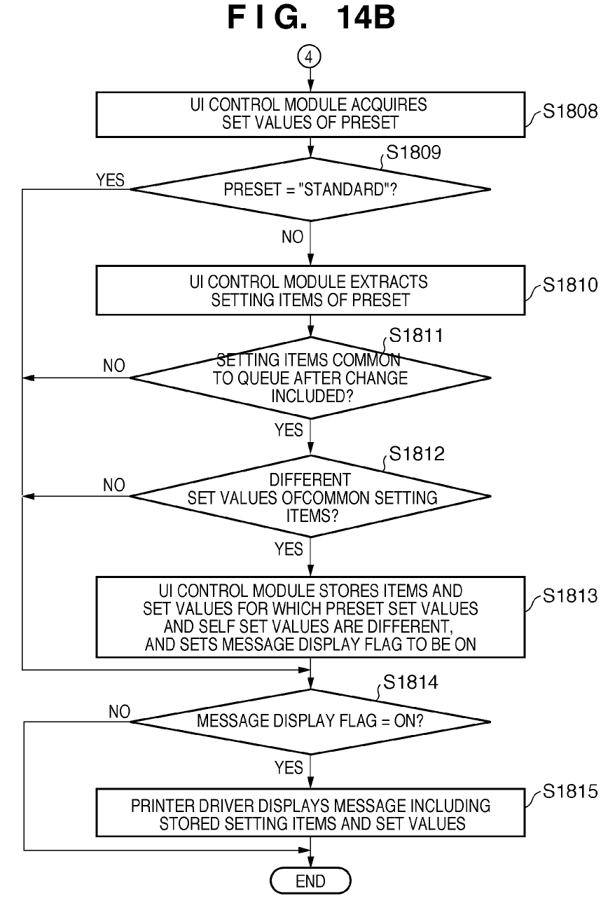

Initially, the OS loads the file “defaultprinter.plist” shown in description 11a in FIG. 11 and stored under the /usr/USER_A/Library/Preferences/ directory, and acquires information of the default print queue. In this case, the OS can recognize that “PrinterA” is the default print queue. Next, the OS loads a printer description file of “PrinterA”. As the printer description file of the print queue “PrinterA”, a printer specification description file having a file name starting with “PrinterA” is loaded from files stored under the /etc/cups/ppd/ directory. Description 13a in FIG. 13 shows the contents of the printer specification description file of “PrinterA”. Since the format of this file is the same as that described using description 8b in FIG. 8, a description thereof will not be repeated. Subsequently, the OS extracts printer setting items and their default values from this printer description file. More specifically, the OS extracts setting items from a keyword “*OpenUI” in the printer specification description file in description 13a in FIG. 13, and default values of these functions from a keyword starting with “*Default”.

In description 13a in FIG. 13, from the keyword “*OpenUI”, the following setting items are extracted.

ColorMode

Duplex

Resolution

Also, for respective functions, the following default values are extracted from the keyword starting with “*Default”.

ColorMode=Color

Duplex=Simplex

Resolution=1200

From the setting items and default set values which are extracted in this way, initial print setting information of the print queue shown in description 11c in FIG. 11 is generated. Note that “ABC.” is appended before the setting items in the lines 1506 to 1508. This is to append a symbol used to identify a vendor since the system uses these pieces of information as crossover print queue setting information, as described above.

Furthermore, in this step, information of the preset is also reflected. Initially, the OS extracts the currently selected preset and its set values from the file “custompresets.plist”, which is shown in description 11b in FIG. 11 and is stored under the /usr/USER_A/Library/Preferences/ directory. As can be seen from the line 1403 of description 11b in FIG. 11, the currently selected preset is “Standard”, and also from the lines 1405 and 1406, the setting contents are empty. Since the settings are empty in this example, the print queue print setting information shown in description 11c in FIG. 11, which is generated in the sequence described so far, is not changed. However, for example, when “Preset1” is selected, the set values in the lines 1408 to 1410 are overwritten on items in the lines 1506 to 1508.

In step S1603, the OS calls the UI control module of the default print queue, and passes the print setting information generated in step S1602 to the UI control module. More specifically, the OS passes the print setting information shown in description 11c in FIG. 11 to the UI control module 805 of the print queue “PrinterA”. As a result of the sequence described so far, the print setting dialog 1201 shown in FIG. 10 is displayed. Then, the user inputs desired instructions on this dialog in an arbitrary order. That is, the user inputs a print queue change instruction in the setting field 1202, a preset change instruction in the setting field 1203, print attribute change instructions (in the setting field 1204 and subsequent fields), and a print instruction using the print button 1210.

Operations of respective steps will be described below. A user operation received in step S1604 is determined in steps S1605, S1607, and S1609.

In step S1604, the OS receives a user instruction, and executes a corresponding operation based on the contents of the instruction. If it is determined in step S1605 that the user changes a preset, the process advances to step S1606. In step S1606, the OS passes print setting information of the selected preset to the UI control module of the current print queue via an API. For example, when the user changes the preset from “Standard” to “Preset1”, the OS changes the preset name in the line 1403 in the preset print setting file shown in description 11b in FIG. 11 from “Standard” to “Preset1”, and passes that file to the UI control module.

If it is determined in step S1607 based on the instruction received in step S1604 that the user changes a print queue, the process advances to step S1608. In step S1608, the OS acquires the print setting information of the print queue before selection from the UI control module of the print queue before selection via the API. Then, the OS passes the acquired print setting information to a UI control module of the print queue after selection via the API. Note that the operation of the UI control module which received this print setting information will be described in detail later.

If the user selects a print or cancel instruction in step S1604, the process advances to step S1609. If it is determined in step S1609 that the user instruction is a cancel instruction, the OS closes the print setting dialog 1201 and ends the processing. If the user instruction is a print instruction, the OS acquires the print setting information of the current print queue from the UI control module, and executes a print operation. Note that this print operation is executed when the OS passes the print setting information to the graphic rendering module 803. However, since this operation is general, and is not directly related to the present invention, a description thereof will not be given. As described above, under the control of the OS as the precondition of the present invention, the function of sharing print items and set values between a plurality of printer drivers is implemented.

[Set Value Notification Method]

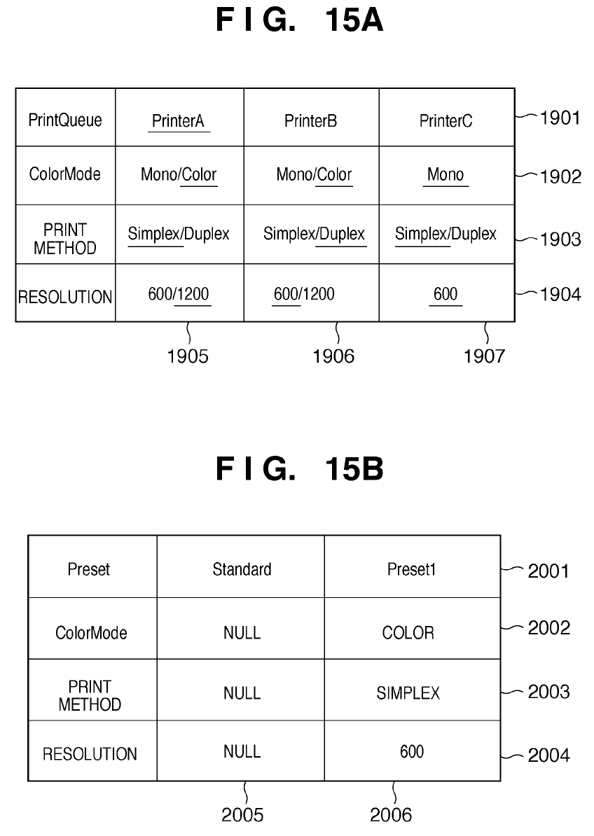

The set value notification method of the print queue will be described below. FIGS. 14A and 14B are flowcharts showing the sequence of the notification method. This flowchart will be described under the following preconditions.

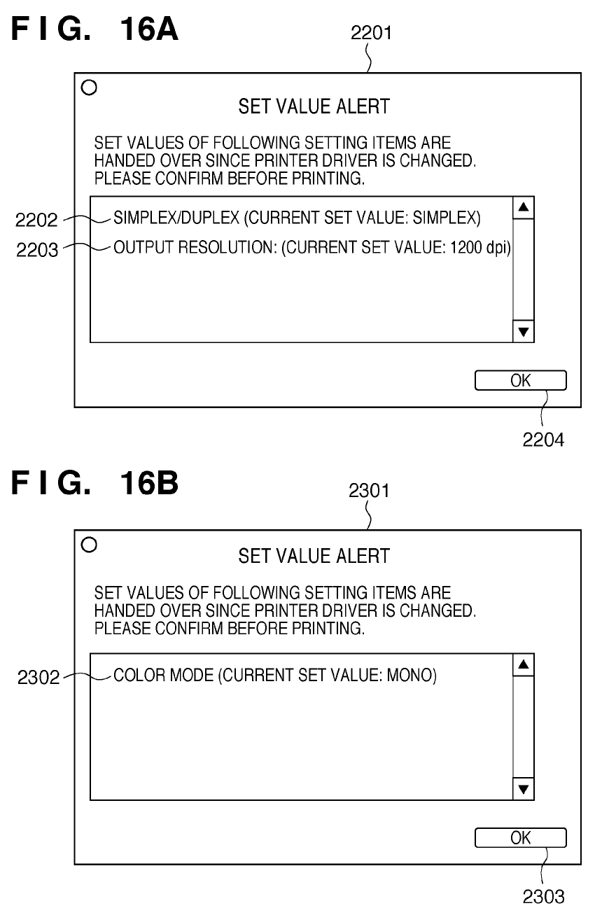

FIG. 15A shows settings associated with print queues. Referring to FIG. 15A, assume that as print queues, “PrinterA” as a print queue 1905, “PrinterB” as a print queue 1906, and “PrinterC” as a print queue 1907 are registered. Also, settable values and default set values of the respective print queues are as follows. Note that the default values of the print queues are underlined in FIG. 15A.

For example, for “PrinterA”, “color” or “monochrome” is selectable as a color mode, and its default set value is “color”. Also, “simplex” or “duplex” is selectable as a duplex setting, and its default set value is “simplex”. “600” or “1200” is selectable as a “Resolution” item, and its default value is “1200”. “PrinterB” and “PrinterC” are as described in the table in FIG. 15A. Note that FIG. 15A shows the aforementioned three functions, but each print queue includes many functions in addition to these functions. However, since those functions can be handled in the same manner as in these three functions, they are not shown in FIG. 15A.

FIG. 15B exemplifies settings associated with presets. Referring to FIG. 15B, a “preset” column 2001 includes two presets “Standard” and “Preset1”. The preset “Standard” is a standard preset, and includes set values “NULL” in all setting items. The preset “Preset1” includes a color mode=“color”, a print method=“simplex”, and a resolution=“600”. Also, assume that the user selects “print” from an application menu to open the print setting dialog 1201, and then makes the following changes. Since the default print queue is “PrinterA”, the print queue “PrinterA” is selected on the print setting dialog 1201. In this state, assume that the user changes the print queue to “PrinterB”. The operation when the user changes the print queue to “PrinterB” will be described below.

A method that allows the UI control module of the printer driver to notify the user of print set values will be described below along the sequence shown in FIGS. 14A and 14B. Note that the sequence shown in FIGS. 14A and 14B corresponds to the operation on the UI control module side when the OS calls the UI control module of the printer driver in step S1608 in FIG. 12.

In step S1801, the UI control module of the printer driver acquires the print setting information shown in description 11c in FIG. 11 from the OS. In step S1802, the UI control module of the printer driver then sets a message display flag to be OFF. This message display flag is one variable which is held by the UI control module in an application process (in a UI control module process) on the RAM 204. In step S1803, the UI control module of the printer driver extracts setting items common to those of the acquired print setting information and to those of the given print queue.

[Case 1]

The following description will be given using practical cases. As can be seen from the acquired print setting information shown in description 11c in FIG. 11, setting items are as follows.

ABC.ColorMode

ABC.Duplex

ABC.Resolution

As the setting items to be set, the following print setting items are acquired from the printer specification description file. Note that description 13b in FIG. 13 shows the printer specification description file of “PrinterB”. Since the contents are the same as those of the printer specification description files shown in description 8b in FIG. 8 and description 13a in FIG. 13, a description thereof will not be given.

ColorMode

Duplex

Resolution

Note that since this case describes printer drivers of a vendor “ABC”, these three setting items are common items.

The UI control module determines in step S1804 whether or not the setting items between the printer drivers corresponding to the print queues before and after switching include common setting items. This process implements a setting item determination step. In the example used in this case, since the common setting items are included, the process advances to step S1805. Note that if no common setting items are included, processing related to print setting items is skipped, and the process jumps to processing related to a preset, which starts from step S1808.

In step S1805, the UI control module of the printer driver extracts the set values of the print setting information acquired from the OS and default values of the given print queue in association with the common items. The print set values acquired from the OS in association with the common setting items are as follows.

ABC.ColorMode=Color

ABC.Duplex=Simplex

ABC.Resolution=1200

Also, as the default values of the given print queue, the following values are acquired from the printer specification description file shown in description 13b in FIG. 13.

ColorMode=Color

Duplex=Duplex

Resolution=600

In step S1806, the UI control module compares the extracted print set values. This process implements a set value determination step. As can be seen from the above two sets of set values, the set values of the “ColorMode” item match, but those associated with “Duplex” and “Resolution” items are different. As a result of determination, since the set values are different, the process advances to step S1807. If the print set values match, the processing in step S1807 is skipped, and the process jumps to processing related to a preset in step S1808 and subsequent steps.

In step S1807, the UI control module of the printer driver stores setting items and set values in association with items for which the set values of the print setting information acquired from the OS are different from the default values of the given print queue, and sets the message display flag to be ON. The setting items and set values stored in this step are as follows.

ABC.Duplex=Simplex

ABC.Resolution=1200

In step S1808, the UI control module of the printer driver acquires a set value of a preset. This process is implemented when the UI control module acquires a set value of “LastPreset” in the line 1403 from “custompresets.plist” shown in description 11b in FIG. 11. Since a value acquired in this step is “Standard”, YES is determined in step S1809, and the process jumps to step S1814.

Since it is determined in step S1814 that the message display flag is “ON”, the process advances to step S1815. The processing in this step will be described in detail below. The UI control module of the printer driver summarizes different items and set values between the print setting information acquired from the OS and default values of the given print queue, and different set values from preset set values, all of which are stored in steps S1807 and S1813. More specifically, in this case, the items and set values to be summarized are as follows.

ABC.Duplex=Simplex

ABC.Resolution=1200

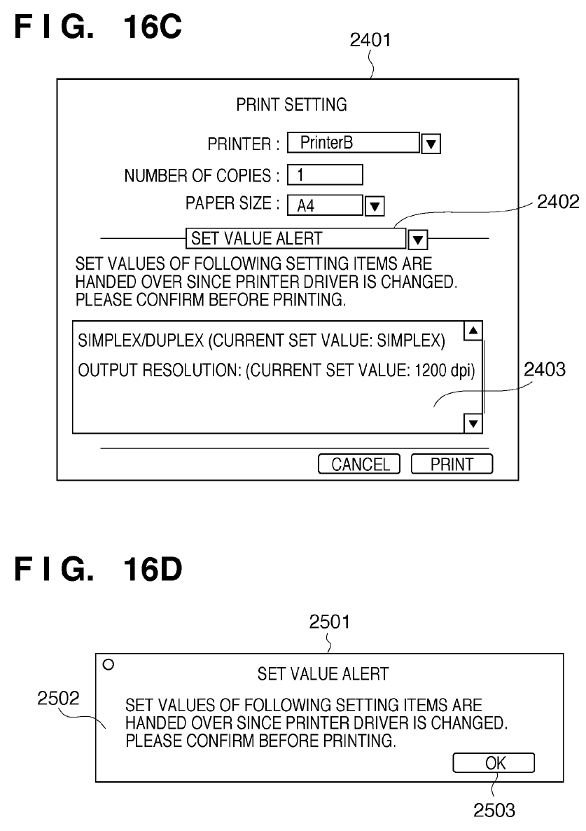

Based on these pieces of information, the UI control module of the printer driver displays a new message display dialog 2201 exemplified in FIG. 16A. As a display example in this case, a message 2202 displays that the current print set value of a simplex/duplex setting is “Simplex”, and a message 2203 displays that the resolution is 1200 dpi (1200). The user can modify print settings while confirming this dialog. When the user presses an “OK” button after modification, the dialog can be closed.

The aforementioned processing can call user's attention about the fact that set values associated with print processing have changed as a result of switching of output target printers (print queues).

That is, the print setting items upon selection of “PrinterA” when the user opens the print setting dialog 1201 are as follows.

ColorMode=Color

Duplex=Simplex

Resolution=1200

When the user switches the print queue to “PrinterB” while the set values of the respective items are in the above state, the OS shares and hands over set values of “PrinterA”. However, assume that default set values of “PrinterB” are as follows.

ColorMode=Color

Duplex=Duplex

Resolution=600

In this case, although the print queue is switched to “PrinterB”, the default values of “PrinterB” have not been reflected in association with the setting items “Duplex” and “Resolution”. However, by executing the aforementioned processing, the user can be informed that default set values have not been reflected.

As a next case, assume that after the user selects “print” from an application menu to open the print setting dialog 1201, he or she makes the following changes.
On the print setting dialog 1201, the print queue “PrinterA” is selected as a default print queue [case 2].
After that, the user changes a preset to “Preset1” [case 2].
After that, the user switches the print queue to “PrinterC” [case 2].
After that, the user switches the print queue to “PrinterA” [case 3].

Note that since the same as in the above description applies to the change of the print queue, a description thereof will not be repeated, and the change of the preset and the final change of the set values will be described in detail below.

### [Case 2]

When the user selects “print” from an application menu to open the print setting dialog 1201, the print setting information has the following contents.

ABC.ColorMode=Color

ABC.Duplex=Simplex

ABC.Resolution=1200

Next, since the user selects “Preset1”, the OS passes print setting information of the selected preset to the UI control module of the current print queue in step S1606. More specifically, the UI control module acquires information in which “LastPreset”=“Preset1” in the line 1403 in description 11b in FIG. 11 from the OS. Since the preset is changed, the print setting information has the following contents.

ABC.ColorMode=Color

ABC.Duplex=Simplex

ABC.Resolution=600

Next, the user changes the print queue to “PrinterC”. Since the print queue is changed, the OS executes the processing shown in FIGS. 14A and 14B in step S1608. However, since the processes of these steps are the same as those described above, a description thereof will not be repeated. As a result, the print setting information has the following contents.

ABC.ColorMode=Mono

ABC.Duplex=Simplex

ABC.Resolution=600

It should be noted that a printer corresponding to the print queue “PrinterC” is a monochrome printer. Hence, in the setting item “ColorMode” in the print queue “PrinterC”, only “monochrome” (Mono) is set. For this reason, the set value of the item “ColorMode” is forcibly set to be “Mono”.

[Case 3]

A case in which the user changes the print queue to “PrinterA” again will be described below along the processing in FIGS. 14A and 14B. Since steps S1801 to S1808 are the same as those in the above description, a description thereof will not be repeated. Note that in this processing, the initial print setting information has the following contents.

ABC.ColorMode=Mono

ABC.Duplex=Simplex

ABC.Resolution=600

Also, the default set values of the print queue “PrinterC” are as follows. In this case, since respective items do not have different values, the message display flag is not set (it is kept OFF).

ABC.ColorMode=Mono

ABC.Duplex=Simplex

ABC.Resolution=600

Next, since it is determined in step S1809 that the currently selected preset is not “Standard” but “Preset1”, the process advances to step S1810. In step S1810, the UI control module extracts setting items of “Preset1”. As can be seen from “custompreset.plist” in description 11b in FIG. 11, the setting items of “Preset1” are as follows.

ABC.ColorMode

ABC.Duplex

ABC.Resolution

The UI control module then determines in step S1811 whether or not common setting items to those of the print queue “PrinterC” after change are included. This process implements a preset item determination step. In this case, since ColorMode, Duplex, and Resolution are common setting items, the process advances to step S1812.

The UI control module of the printer driver determines in step S1812 whether or not the common setting items have different print set values. This process implements a preset set value determination step. In this case, the set values of “Preset1” are as follows.

ABC.ColorMode=Color

ABC.Duplex=Simplex

ABC.Resolution=600

Also, the set values before switching are as follows.

ABC.ColorMode=Mono

ABC.Duplex=Simplex

ABC.Resolution=600

The UI control module detects that the item “ABC.ColorMode” has a different set value. For this reason, the process advances to step S1813, and the UI control module of the printer driver stores a different set value of the common setting item and sets the message display flag to be ON. Subsequently, since it is determined in step S1814 that the message display flag is ON, the process advances to step S1815 to display a message display dialog 2301 shown in FIG. 16B. In this case, the UI control module can notify the user of the item “ColorMode”=“Mono” using the message display dialog 2301.

With the above sequence, since the user sets “Preset1”, the item “ColorMode” is to be set as “Color”, and the above processing can call user's attention about the item “ColorMode”=“Mono”.

### Second Embodiment

The second embodiment will be described below using FIGS. 1 to 15B and FIG. 16C. Note that since FIGS. 1 to 15B are the same as in the first embodiment, a description thereof will not be repeated.

In the first embodiment, in step S1815 in FIG. 14B, a printer driver displays a message indicating the contents of set values for the user. By contrast, the second embodiment displays the contents of this message as one group of the printer driver.

FIG. 16C shows a display example in the processing in step S1815 in FIG. 14B. On a print setting dialog 2401 provided by the printer driver, message contents corresponding to a display group “set value alert” in a setting field 2402 are displayed on an area 2403. Although not shown in FIG. 16C, the print setting dialog may accept a change of a set value for a setting item having a different set value.

As a result, the user can recognize a change of the print set value, and can change the set value within the same dialog. Hence, the need for displaying a plurality of dialogs can be obviated.

### Third Embodiment

The third embodiment will be described below using FIGS. 1 to 15B and FIGS. 16C and 16D. Note that since FIGS. 1 to 15B and FIG. 16C are the same as in the second embodiment, a description thereof will not be repeated. In the second embodiment, FIGS. 1 to 15B and FIG. 16C are the same.

However, since the user cannot recognize the presence/absence of an alert unless he or she opens a set value alert group in a setting field 2402 on a print setting dialog of a printer driver in the second embodiment, a message indicating only the presence of an alert is displayed in this embodiment. FIG. 16D shows that message display dialog 2501, in which a message 2502 displays that there is a set value alert. Upon pressing an OK button 2503, this dialog is closed. Note that the configuration of the message display dialog in this embodiment is an example, and the present invention is not limited to this. For example, a setting item having a different set item may be appended with a specific mark on the dialog.

This message allows the user to recognize a change of the set value, and can prompt the user to confirm it.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-211026, filed Sep. 11, 2009, which is hereby incorporated by reference herein in its entirety.

What is claimed is:

1. A control method of an information processing apparatus in which a plurality of printer drivers for setting set values in setting items of print data to be output by a printing apparatus are installed, the method comprising:
under the control of an operating system having a function of controlling the plurality of printer drivers to share set values set using the plurality of printer drivers,
an item determination step of determining, upon switching of output target printing apparatuses between a plurality of printing apparatuses corresponding to the plurality of printer drivers, whether or not setting items in setting information before switching and setting items according to a printing apparatus after switching include common setting items;
a set value determination step of determining whether or not set values in the setting information before switching and default set values of the printing apparatus after switching are different in the common setting items determined in the item determination step; and
an output step of outputting, when it is determined in the set value determination step that the set values are different, a message indicating that set values different from the default set values of the printing apparatus after switching are set upon switching of the printing apparatuses.

2. The method according to claim 1, further comprising:
a storage step of storing a preset which defines, in advance, print setting items and set values to be set in the print data;
a preset item determination step of determining, upon switching of the printing apparatuses, whether or not setting items of the preset and the setting items according to the printing apparatus after switching include common setting items; and
a preset set value determination step of determining whether or not the set values of the preset and the set values set in the common setting items upon switching of the printing apparatuses are different in the common setting items determined in the preset item determination step,
wherein in the output step, when it is determined in the preset setting value determination step that the set values are different, a message indicating that set values different from the set values of the preset are set upon switching of the printing apparatus is output.

3. The method according to claim 1, wherein in the output step, the message is output on a print setting dialog.

4. The method according to claim 1, wherein in the output step, the message is output using a new dialog.

5. A control method of an information processing apparatus in which a plurality of printer drivers for setting set values in setting items of print data to be output by a printing apparatus are installed, the method comprising:
under the control of an operating system having a function of controlling the plurality of printer drivers to share set values set using the plurality of printer drivers,
a storage step of storing a preset which defines, in advance, print setting items and set values to be set in the print data;
a preset item determination step of determining, upon switching of output target printing apparatuses between a plurality of printing apparatuses corresponding to the plurality of printer drivers, whether or not setting items of the preset and the setting items according to the printing apparatus after switching include common setting items;
a preset set value determination step of determining whether or not the set values of the preset and the set values set in the common setting items upon switching of the printing apparatuses are different in the common setting items determined in the preset item determination step; and
an output step of outputting, when it is determined in the preset set value determination step that the set values are different, a message indicating set values different from the set values of the preset are set upon switching of the printing apparatus.

6. An information processing apparatus in which a plurality of printer drivers for setting set values in setting items of print data to be output by a printing apparatus are installed, said apparatus comprising:
under the control of an operating system having a function of controlling the plurality of printer drivers to share set values set using the plurality of printer drivers,
an item determination unit which determines, upon switching of output target printing apparatuses between a plurality of printing apparatuses corresponding to the plurality of printer drivers, whether or not setting items in setting information before switching and setting items according to a printing apparatus after switching include common setting items;
a set value determination unit which determines whether or not set values in the setting information before switching and default set values of the printing apparatus after switching are different in the common setting items determined by said item determination unit; and
an output unit which outputs, when said set value determination unit determines that the set values are different, a message indicating that set values different from the default set values of the printing apparatus after switching are set upon switching of the printing apparatuses.

7. An information processing apparatus in which a plurality of printer drivers for setting set values in setting items of print data to be output by a printing apparatus are installed, said apparatus comprising:
under the control of an operating system having a function of controlling the plurality of printer drivers to share set values set using the plurality of printer drivers,
a storage unit which stores a preset which defines, in advance, print setting items and set values to be set in the print data;
a preset item determination unit which determines, upon switching of output target printing apparatuses between a plurality of printing apparatuses corresponding to the plurality of printer drivers, whether or not setting items of the preset and the setting items according to the printing apparatus after switching include common setting items;
a preset set value determination unit which determines whether or not the set values of the preset and the set values set in the common setting items upon switching of the printing apparatuses are different in the common setting items determined by said preset item determination unit; and
an output unit which outputs, when said preset set value determination unit determines that the set values are different, a message indicating that set values different from the set values of the preset are set upon switching of the printing apparatus.

8. A computer-readable medium storing a program for making a computer function as:
under the control of an operating system having a function of controlling a plurality of printer drivers to share set values set using the plurality of printer drivers,
an item determination unit which determines, upon switching of output target printing apparatuses between a plurality of printing apparatuses corresponding to the plurality of printer drivers, whether or not setting items in setting information before switching and setting items according to a printing apparatus after switching include common setting items;
a set value determination unit which determines whether or not set values in the setting information before switching and default set values of the printing apparatus after switching are different in the common setting items determined by said item determination unit; and
an output unit which outputs, when said set value determination unit determines that the set values are different, a message indicating that set values different from the default set values of the printing apparatus after switching are set upon switching of the printing apparatuses.

9. A computer-readable medium storing a program for making a computer function as:
under the control of an operating system having a function of controlling a plurality of printer drivers to share set values set using the plurality of printer drivers,
a storage unit which stores a preset which defines, in advance, print setting items and set values to be set in print data;
a preset item determination unit which determines, upon switching of output target printing apparatuses between a plurality of printing apparatuses corresponding to the plurality of printer drivers, whether or not setting items of the preset and the setting items according to the printing apparatus after switching include common setting items;
a preset set value determination unit which determines whether or not the set values of the preset and the set values set in the common setting items upon switching of the printing apparatuses are different in the common setting items determined by said preset item determination unit; and
an output unit which outputs, when said preset set value determination unit determines that the set values are different, a message indicating that set values different from the set values of the preset are set upon switching of the printing apparatus.
